(19) United States
(12) Patent Application Publication
(10) Pub. No.: US 2026/0036952 A1
(43) Pub. Date: Feb. 5, 2026

(54) Systems And Methods For Enhancing Drone Deployment

(71) Applicant: Skydio, Inc., San Mateo, CA (US)

(72) Inventors: Adam Parker Bry, Redwood City, CA (US); John Santry, San Mateo, CA (US); Katrina Armistead, San Mateo, CA (US); Varun Kalappa, San Mateo, CA (US); Vincent Lecrubier, Lisboa (PT)

(21) Appl. No.: 19/286,492

(22) Filed: Jul. 31, 2025

Related U.S. Application Data
(60) Provisional application No. 63/677,762, filed on Jul. 31, 2024.

(51) Int. Cl. G05B 13/04; G05D 1/644; G05D 1/69; G05D 105/55; G05D 109/25

(52) U.S. Cl. CPC G05B 13/042; G05D 1/644; G05D 1/69; G05D 2105/55; G05D 2109/254

(57) ABSTRACT

Disclosed is a system for determining drone deployment configuration using simulation of autonomous drone operations under real-world constraints. A deployment simulation engine is executed to evaluate multiple drone deployment configurations based on real-world historical incident data, drone specification, and geospatial constraints. The simulation engine computes performance metrics including any of response time, energy-constrained on-station time, mission duration, and incident coverage levels. These performance metrics are evaluated against a design parameter such as target coverage thresholds or target on-station time. A drone deployment optimization engine then determines a drone deployment configuration that satisfies the design parameters. The deployment configuration typically includes deployment parameters such as number of drone hives, drone hive geolocations, or drones per hive.

### CROSS-REFERENCE TO RELATED APPLICATION(S)

This application claims the benefit of U.S. Provisional Patent Application No. 63/677,762, filed Jul. 31, 2024, the entire disclosure of which is hereby incorporated by reference.

### TECHNICAL FIELD

This disclosure relates to unmanned aerial vehicles (UAVs), and more specifically, to optimizing deployment of autonomous UAVs.

### BACKGROUND

Autonomous drones or unmanned aerial vehicles (UAVs) are increasingly being used for applications such as package delivery, surveillance, public safety, disaster response, and infrastructure inspection tasks among others. In particular, drone systems are being evaluated for their ability to rapidly respond to incident events such as 911 calls, infrastructure failures, or security alerts. These systems promise to reduce response times, enhance situational awareness, and optimize human resource allocation.

In many jurisdictions, fixed-location emergency services (e.g., patrol vehicles or fire stations) rely on human deployment strategies that are not optimized for speed or geographic coverage. Existing drone deployments, if used at all, are largely ad hoc and not data-driven. Conventional drone deployments, however, are largely manual in nature. Deployment decisions regarding where to station drones, how many drones are required, and how they should be distributed across a region are often based on heuristics or fixed-location assumptions, lacks analytical rigor. These approaches do not account for the actual distribution of historical incident data, environmental or regulatory constraints on drone flight, or the performance characteristics of the drone platforms themselves. As a result, deployments may be inefficient, may fail to meet desired response.

Some existing systems attempt to incorporate basic data overlays or map-based planning tools. However, these systems typically lack the ability to simulate drone behavior under real-world constraints. For example, they may not model energy-constrained flight envelopes, recharge cycles, or response time feasibility across varied deployment configurations. Furthermore, such systems rarely offer the ability to systematically evaluate multiple candidate deployment configurations to determine which best satisfies operational goals, such as coverage percentage or on-station time at the target location. These and other drawbacks exist.

### SUMMARY

In some aspects, the techniques described herein relate to computer-implemented method for generating drone deployment configuration using simulation of autonomous drone operations. The method includes: receiving, via a first graphical user interface (GUI), a dataset of incident events, wherein each incident event includes at least a timestamp and geospatial location; receiving operational constraint data including geospatial constraint data, wherein the geospatial constraint data includes at least one of operational boundaries, drone-restricted areas, or candidate deployment locations; executing a drone deployment simulation engine to compute, for each of multiple drone deployment configurations, performance metrics including at least a response time, an energy-constrained on-station time for responding drones and a projected incident coverage level based on the operational constraint data; and determining, using a drone deployment optimization engine, a drone deployment configuration with the projected incident coverage level that satisfies a specified target coverage level, wherein the drone deployment configuration includes a set of drone hive geolocations.

In some aspects, the techniques described herein relate to a system for configuring autonomous drone deployments for responding to incident events, including: a processor and a memory storing instructions that, when executed, cause the processor to: receive a dataset of incident events including timestamps and geospatial coordinates of the incident events; receive design parameters including a specified target coverage level and a specified target on-station time; for each of a plurality of drone deployment configurations: execute a drone deployment simulation engine to compute, for each incident, performance metrics including a response time, an energy-constrained on-station duration, and total mission time based on drone specifications; and execute a drone deployment optimization engine to: evaluate the performance metrics for each drone deployment configuration to determine whether a drone deployment configuration satisfies the design parameters, and output a selected drone deployment configuration including drone hive geolocations, number of drones per hive, and expected response performance metrics.

In some aspects, the techniques described herein relate to a non-transitory computer-readable medium storing instructions that, when executed by one or more processors, cause a processing system to perform operations comprising: obtaining incident event data including geospatial coordinates and timestamps; obtaining geospatial constraint data specifying drone-restricted zones and candidate drone hive locations; receiving design parameters including a specified target coverage level; simulating autonomous drone operations over multiple drone deployment configurations to determine to compute performance metrics including projected incident coverage level based on the geospatial constraint data and the design parameters; and selecting a drone deployment configuration including drone hive geolocations, drone count in each drone hive geolocation based on the projected incident coverage level satisfying the specified target coverage level.

In some aspects, the system provides a preview mode, wherein a user supplies limited information such as a city name, estimated area population, or geographic bounding region, and receives a coarse recommendation for drone hive count, placement distribution, and expected incident coverage. This mode supports early-stage planning, proposal generation, or sales demonstration workflows without requiring full incident datasets.

Various other aspects, features, and advantages of the disclosed embodiments will be apparent through the detailed description and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 illustrates an example configuration of a top side of an unmanned aerial vehicle (UAV), consistent with various embodiments.

FIG. 2 illustrates an example configuration of a bottom side of the UAV, consistent with various embodiments.

FIG. 3 illustrates an example UAV architecture, consistent with various embodiments.

FIG. 4 illustrates a drone deployment configuration generation system, consistent with various embodiments.

FIG. 5 illustrates a first graphical user interface (GUI) that allows a user to upload operational datasets required for autonomous drone deployment simulation, consistent with various embodiments.

FIG. 6 illustrates a second GUI that enables a user to specify drone specification parameters, consistent with various embodiments.

FIG. 7 illustrates a third GUI for inputting design parameters and reviewing simulation results for autonomous drone deployment planning, consistent with various embodiments.

FIG. 8 illustrates a flow diagram of method for simulating and optimizing drone deployment configurations, consistent with various embodiments.

FIG. 9 illustrates a flow diagram of method for computing performance metrics of a deployment configuration, consistent with various embodiments.

FIG. 10 illustrates a flow diagram of method for computing the incident coverage level relative to drone availability, consistent with various embodiments.

Embodiments will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

### DETAILED DESCRIPTION

Disclosed are embodiments for determining drone deployment configurations using simulation of autonomous drone operations under real-world constraints. A drone deployment simulation engine is executed to evaluate multiple drone deployment configurations based on real-world historical incident data, drone specification, and geospatial constraints. The simulation engine computes performance metrics including response time, energy-constrained on-station time, mission duration, and incident coverage levels. These performance metrics are evaluated against one or more design parameters such as target coverage thresholds and target on-station time. A drone deployment optimization engine then determines a drone deployment configuration that satisfies the design parameters. The drone deployment configuration typically includes deployment parameters such as number of drone hives, drone hive geolocations, or drones per hive.

Drone deployment configurations may be generated by varying the number of drone hives and the geolocations of the hives. For each configuration, the simulation engine may determine various performance metrics. For example, the simulation engine executes a response function that calculates metrics based on drone specifications and geographic distance to the incident locations. Drone specifications may include takeoff time, cruise speed, battery capacity, maximum loiter time, and recharge duration. The simulation engine may also execute a scheduling function to simulate drone assignment over time using launch and release events, thereby computing the number of incidents covered for each deployment configuration given a fixed number of drones per hive.

In some embodiments, the incident dataset is filtered based on user-defined geospatial parameters. A clustering algorithm may then be applied to the filtered dataset to determine candidate drone hive geolocations based on incident density and flight range constraints. In some embodiments, the hive geolocations may also be determined using a trained machine learning (ML) model based on various parameters such as incident density, drone specifications, geospatial constraints (e.g., where drones have to deployed, should not be deployed, etc.). Simulation results may be visualized using graphical overlays, including response zones for each hive derived from computed flight time and loiter capabilities. In certain embodiments, response time performance is compared to historical response times of ground-based units to further refine the selected configuration.

The embodiments generate various drone deployment configurations, simulate each drone deployment configuration, and determines one or more deployment configurations that satisfy the design parameters. Drones may be deployed based on the selected deployment configurations to respond to the incident events.

The disclosed embodiments provide significant advantages over prior approaches. Simulation-based evaluation allows drone deployment configurations to be assessed under real-world constraints rather than relying on static planning or heuristics. Scheduling logic and resource availability are modeled over time, enabling accurate prediction of drone requirements and response feasibility. The ability to simulate multiple configurations, including varying numbers of hives and drone assignments, allows optimal coverage with fewer resources. Integration of clustering and data filtering enables targeted, data-driven deployment tailored to actual incident patterns within a geographic region. These capabilities result in improved responsiveness, better resource utilization, and deployment strategies that can adapt to complex operational requirements.

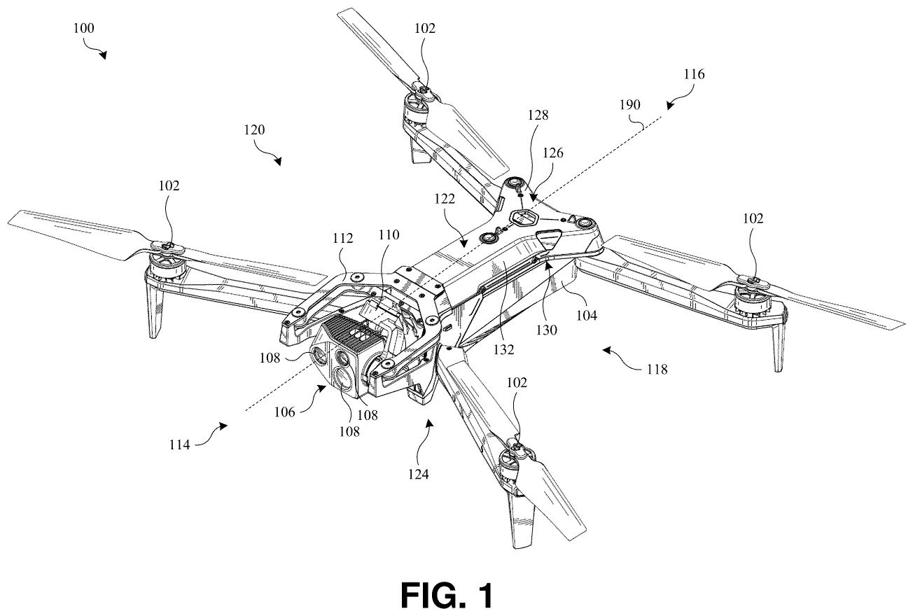

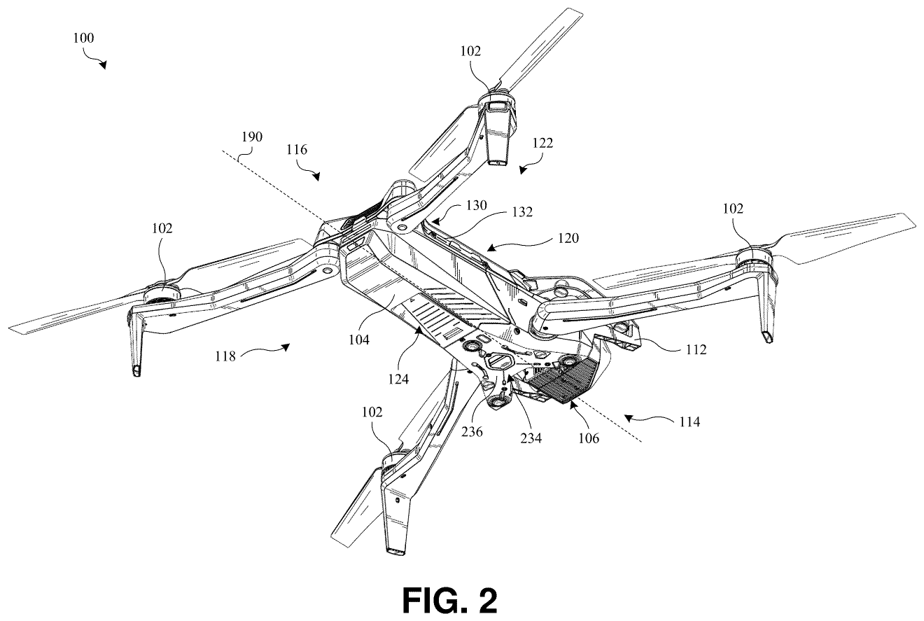

Turning now to the figures, FIG. 1 illustrates a top perspective view of an unmanned aerial vehicle (UAV) 100. FIG. 2 illustrates a bottom perspective view of the UAV 100.

The UAV 100 may include one or more propulsion mechanisms 102 and a power source, such as a battery coupled to the UAV 100. The UAV 100 may be configured for autonomous landing and/or docking with a docking station. To support the autonomous landing and/or docking, the UAV 100 may follow any suitable processes or procedures, or may include one or more components, such as those described in U.S. application Ser. No. 16/991,122, filed Aug. 12, 2020, and U.S. Provisional Application No. 63/527,261, filed on Jul. 17, 2023, the entire disclosures of which are hereby incorporated by reference for all purposes.

The propulsion mechanisms 102 may include any components and/or structures suitable for supporting flight of the UAV 100. For example, as shown in FIGS. 1 and 2, the propulsion mechanisms 102 may be or may include propeller assemblies having one or more blades connected to hubs of the UAV 100. The one or more blades may be propelled by a motor to rotate the one or more blades and facilitate flight of the UAV 100, whereby the motor may be powered by a power source of the UAV 100, such as the battery 104. It should be appreciated, however, that the configuration and/or structure of the UAV 100 may vary depending on the particular configuration of the UAV 100, and as such, the UAV 100 shown in FIG. 1 is not intended to limit the structure of the UAV 100.

As mentioned above, the UAV 100 may be configured using various processes or protocols to autonomously land (e.g., on a docking station), to autonomously take flight (e.g., from a docking station), or both. To facilitate autonomous landing and/or autonomous flight, the UAV 100 may include one or more sensors, such as image sensors, that are configured to monitor a position of the UAV 100 and/or detect a specified image, such as a fiducial disposed on a docking station. For example, during a landing sequence (e.g., a docking sequence) of the UAV 100, the image sensors of the UAV 100 may detect an image, such as the fiducial disposed on the docking station, to properly align and guide the UAV 100 to dock.

The UAV 100 may further include a camera system 106. The camera system 106 may be configured to detect, monitor, capture, record, or a combination thereof one or more images. The camera system 106 may be configured to facilitate autonomous or user-controlled flight of the UAV 100. For example, the camera system 106 may include one or more cameras 108. The cameras 108 may capture a live feed of an environment during flight, whereby a user via a user interface (e.g., a controller) may control the UAV 100 based upon the live feed of the environment. Alternatively, or additionally, the cameras 108 may capture images of the environment and/or monitor the environment in real-time to autonomously fly through the environment. It should be noted that the cameras 108 and the camera system 106 are not limited to any particular configuration, and any types of camera configurations (e.g., wide-angle, high-resolution, etc.) may be implemented in the UAV 100.

The camera system 106 may be operable via a gimbal system 110 coupled to the camera system 106. The gimbal system 110 may be configured to be controlled autonomously or via a user interface (e.g., a controller) to orient or otherwise move the camera system 106 (e.g., the cameras 108) relative to the UAV 100. The gimbal system 110 may include one or more arms and one or more pivot joints that facilitate movement of the camera system 106 relative to the UAV 100.

The gimbal system 110 and the camera system 106 may be coupled to the UAV 100 by a mounting bracket 112. The mounting bracket 112 may be coupled to the UAV 100 by one or more fasteners or other mechanical connection means to secure the gimbal system 110 and the camera system 106 to the UAV 100. The mounting bracket 112 may be coupled to any portion of the UAV 100. By way of example, as shown in FIGS. 1 and 2, the mounting bracket 112 may be coupled to a front 114 (i.e., a front side) of the UAV 100 or a top 122 (i.e., a top side) of the UAV 100 such that the camera system 106 may be positioned in the front 114 of the UAV 100.

That is, the camera system 106 may be located at the front 114 (i.e., the front side) of the UAV 100 so that the cameras 108 may capture an environment in front of the UAV 100 with respect to a forward direction of travel of the UAV 100 (e.g., a direction of travel of the UAV 100 that is substantially parallel to the ground or along the ground). However, in certain configurations, the camera system 106 may also be coupled to another portion of the UAV 100, such as a rear 116 (i.e., rear side) of the UAV 100, a first side 118 of the UAV 100, a second side 120 of the UAV 100, a bottom 124 (i.e., a bottom side) of the UAV 100, or a combination or variation thereof.

As discussed in further detail below, one or more attachments may be coupled to the UAV 100 and operable with the UAV 100 to further customize a user experience of the UAV 100. That is, the one or more attachments may be coupled to the UAV 100 to provide additional functionality to the UAV 100. For example, the one or more attachments may be a global positioning system (GPS) attachment, a microphone and/or speaker attachment, a night vision attachment (e.g., infrared (IR) attachment), a spotlight attachment, a secondary power source attachment (e.g., a secondary battery similar to the battery 104), an antenna or other radio accessory, a secondary camera system similar to or different from the camera system 106, a computer module, or a combination thereof. Thus, it is envisioned that any type of attachments or arrangement of multiple attachments may be configured for securement to the UAV 100. Additionally, as discussed in further detail below, the UAV 100 or a system thereof may be dynamic such that one or more characteristics (e.g., features, functionalities, operations, etc.) of the UAV 100 may be automatically and dynamically adjusted based upon a type of attachment coupled to the UAV 100.

To facilitate coupling one or more attachments to the UAV 100, the UAV 100 may include one or more attachment interfaces. As shown in FIGS. 1 and 2, the UAV 100 may include a plurality of attachment interfaces located on the UAV 100. For example, the UAV 100 may include a top attachment interface 126 located on the top 122 (i.e., the top side) of the UAV 100, a side attachment interface 130 located on the first side 118 of the UAV 100, a side attachment interface 130 located on the second side 120 of the UAV 100 that opposes the first side 118, and a bottom attachment interface 234 located on the bottom 124 (i.e., the bottom side) of the UAV 100.

To further illustrate positioning of such attachment interfaces, as shown in FIGS. 1 and 2, the UAV 100 (e.g., a body of the UAV 100 from which the propulsion mechanisms 102 extend) may extend along a longitudinal axis 190 of the UAV 100 from the front 114 of the UAV 100 to the rear 116 of the UAV 100. That is, the UAV 100 may extend from a first end (e.g., the front 114, which may be considered a forward end of the UAV 100) to an opposing second end (e.g., the rear 116, which may be considered an aft end of the UAV 100) along the longitudinal axis 190, whereby a length of the UAV 100 or a body thereof may be measured from the first end to the second end.

Moreover, the first side 118 of the UAV 100 may oppose the second side 120 of the UAV 100 with respect to the longitudinal axis 190. The first side 118 and second side 120 may be located on opposing sides of the longitudinal axis 190. The first side 118 may be considered a port side of the UAV 100 and the second side 120 may be considered a starboard side of the UAV 100.

Based on the above relative orientations, it can be seen in FIGS. 1 and 2 that the attachment interfaces described above may be positioned in various locations with respect to the longitudinal axis 190 of the UAV 100. For example, the top attachment interface 126 and/or the bottom attachment interface 234 may be located on the top 122 (i.e., the top side) of the UAV 100 and may extend along the longitudinal axis 190 between the first end (e.g., the front 114 or forward end) and the second end (e.g., the rear 116 or aft end) of the UAV 100. Additionally, the side attachment interfaces 130 may be located on the first side 118 and the second side 120 of the UAV 100 such that the side attachment interfaces 130 may be located on opposing sides of the longitudinal axis 190. That is, a first one of the side attachment interfaces 130 may be located on the port side (e.g., the first side 118) of the UAV 100 and a second one of the side attachment interfaces 130 may be located on the starboard side (e.g., the second side 120) of the UAV 100 such that the side attachment interfaces 130 are located on opposing sides of the longitudinal axis 190.

It should be noted that the above relative orientations associated with the UAV 100 are provided for illustrative purposes and should not be construed as limiting the teachings herein. For example, although the front 114 of the UAV 100 may be considered the front end of the UAV 100 and the rear 116 of the UAV 100 may be considered the aft end of the UAV 100, such considerations do not mean that the UAV 100 only travels in a forward direction with the front 114 of the UAV 100 leading the travel. That is, the UAV 100 may travel in any direction (e.g., fore, aft, side-to-side between the port and starboard sides, in an elevational direction, etc.) with respect to the longitudinal axis 190.

Turning now back to the attachment interfaces, it should be noted that such attachment interfaces may be integrated into the UAV 100, such as a housing of the UAV 100, or may be connected to the UAV 100 to allow for attachment of various attachments. That is, the attachment interfaces may provide a connection means to easily and removably couple various attachments to the UAV 100.

By way of example, the top attachment interface 126 may include a top attachment surface 128. The top attachment surface 128 may be located on, or formed with, the top (i.e., the top side) of the UAV 100. The top attachment surface 128 may be configured to receive, support, or otherwise couple to—either directly or indirectly—various attachments. Similarly, the side attachment interfaces 130 may include a side attachment surface 132 located on, or formed with, the first side 118 and/or the second side 120 of the UAV 100. Moreover, the bottom attachment interface 234 may include a bottom attachment surface 236 located on, or formed with, the bottom 124 (i.e., the bottom side) of the UAV 100. Any number of these attachment surfaces may exist for any of the attachment interfaces. That is, an attachment interface may include more than one attachment surface (e.g., a first attachment surface and a second attachment surface).

Based on the above, one or more attachments may be coupled to the top 122 of the UAV 100, the bottom 124 of the UAV 100, the first side 118 of the UAV 100, the second side 120 of the UAV 100, or a combination thereof. Additionally, it is envisioned that the front 114 and/or the rear 116 of the UAV 100 may also in certain configurations include an additional attachment interface. For example, in certain configurations the UAV 100 may remove the camera system 106 from the front 114 of the UAV and couple the camera system 106 to the UAV 100 in another location (e.g., the rear 116). In such a configuration, the front 114 may include an attachment interface for further attachments.

It should also be noted that the attachment interfaces of the UAV 100 may be adapted for universal or common attachment techniques. That is, various types of attachments may be coupled to the same attachment interface. For example, the GPS attachment and the night vision attachment may both be configured to attach to the top attachment interface 126 and the bottom attachment interface 234. Additionally, more than one attachment may be coupled to the UAV 100 at one time and may be powered by the power source (e.g., the battery 104) of the UAV 100. For example, a first attachment (e.g., a GPS attachment) may be coupled to the top attachment interface 126 and a second attachment (e.g., a spotlight attachment) may be coupled to the side attachment interface 130 located on the first side 118 of the UAV 100. Moreover, the attachment interfaces may include one or more additional features, such as heat-sinking components or other cooling components. Based on the above, various configurations and customization may be possible.

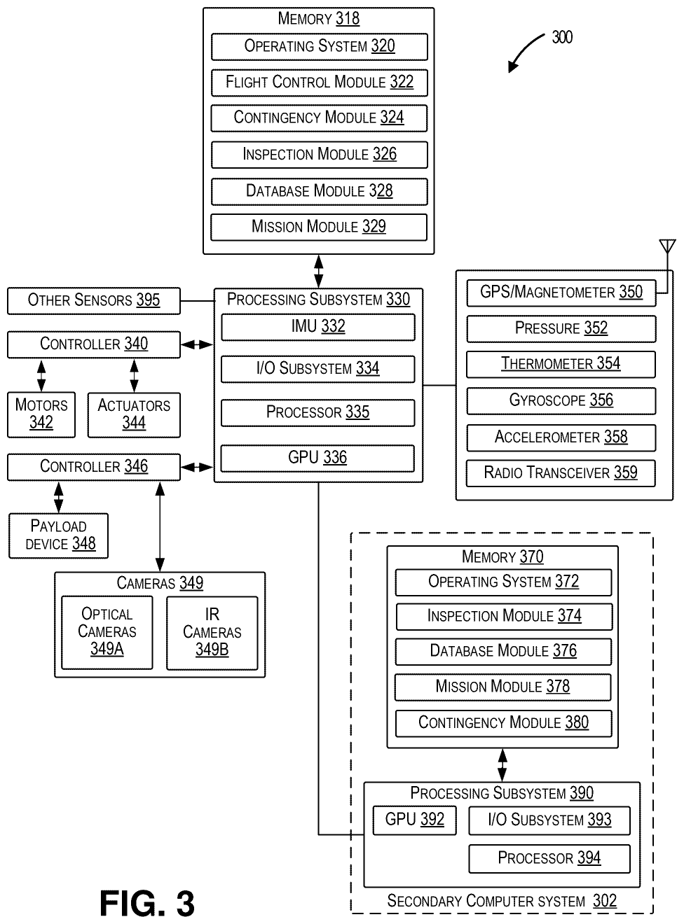

FIG. 3 illustrates an example UAV architecture, consistent with various embodiments. In the examples herein, the UAV 100 may sometimes be referred to as a “drone” and may be implemented as any type of UAV capable of controlled flight without a human pilot onboard. For instance, the UAV 100 may be controlled autonomously by one or more onboard processors, such as processor 335, that execute one or more executable programs. Additionally, or alternatively, the UAV 100 may be controlled via a remote controller, such as through a remotely located controller operated by a human pilot and/or controlled by an executable program executing on or in cooperation with the controller.

A UAV can include a primary computer system 300 and a secondary computer system 302. The UAV primary computer system 300 can be a system of one or more computers, or software executing on a system of one or more computers, which is in communication with, or maintains, one or more databases. The UAV primary computer system 300 can include a processing subsystem 330 including one or more processors 335, graphics processing units 336, I/O subsystem 334, and an inertial measurement unit (IMU) 332. In addition, the UAV primary computer system 300 can include logic circuits, analog circuits, associated volatile and/or non-volatile memory, associated input/output data ports, power ports, etc., and include one or more software processes executing on one or more processors or computers. The UAV primary computer system 300 can include memory 318.

Memory 318 may include non-volatile memory, such as one or more magnetic disk storage devices, solid-state hard drives, or flash memory. Other volatile memory such as RAM, DRAM, SRAM may be used for temporary storage of data while the UAV is operational. Databases may store information describing UAV flight operations, flight plans, contingency events, geofence information, component information and other information.

The UAV primary computer system 300 may be coupled to one or more sensors, such as global navigation satellite system (GNSS) receivers 350 (e.g., GPS receivers), thermometer 354, gyroscopes 356, accelerometers 358, pressure sensors (static or differential) 352, and other sensors 395 that capture perception inputs of a physical environment. The other sensors 395 can include current sensors, voltage sensors, magnetometers, hydrometers, anemometers and motor sensors. The UAV may use IMU 332 in inertial navigation of the UAV. Sensors can be coupled to the UAV primary computer system 300, or to controller boards coupled to the UAV primary computer system 300. One or more communication buses, such as a controller area network (CAN) bus, or signal lines, may couple the various sensor and components.

Various sensors, devices, firmware and other systems may be interconnected to support multiple functions and operations of the UAV. For example, the UAV primary computer system 300 may use various sensors to determine the UAV's current geo-spatial position, attitude, altitude, velocity, direction, pitch, roll, yaw and/or airspeed and to pilot the UAV along a specified flight path and/or to a specified location and/or to control the UAV's attitude, velocity, altitude, and/or airspeed (optionally even when not navigating the UAV along a specific flight path or to a specific location).

The flight control module 322 handles flight control operations of the UAV. The module interacts with one or more controllers 340 that control operation of motors 342 and/or actuators 344. For example, the motors may be used for rotation of propellers, and the actuators may be used for flight surface control such as ailerons, rudders, flaps, landing gear and parachute deployment.

The contingency module 324 monitors and handles contingency events. For example, the contingency module 324 may detect that the UAV has crossed a boundary of a geofence, and then instruct the flight control module 322 to return to a predetermined landing location. The contingency module 324 may detect that the UAV has flown or is flying out of a visual line of sight (VLOS) from a ground operator, and instruct the flight control module 322 to perform a contingency action, e.g., to land at a landing location. Other contingency criteria may be the detection of a low battery or fuel state, a malfunction of an onboard sensor or motor, or a deviation from the flight plan. The foregoing is not meant to be limiting, as other contingency events may be detected. In some instances, if equipped on the UAV, a parachute may be deployed if the motors or actuators fail.

The mission module 329 processes the flight plan, waypoints, and other associated information with the flight plan as provided to the UAV in a flight package. The mission module 329 works in conjunction with the flight control module 322. For example, the mission module may send information concerning the flight plan to the flight control module 322, for example waypoints (e.g., latitude, longitude and altitude), flight velocity, so that the flight control module 322 can autopilot the UAV.

The UAV may have various devices connected to the UAV for performing a variety of tasks, such as data collection. For example, the UAV may carry one or more cameras 349. Cameras 349 can include one or more visible light cameras 349A, which can be, for example, a still image camera, a video camera, or a multispectral camera. The UAV may carry one or more infrared cameras 349B. Each infrared camera 349B can include a thermal sensor configured to capture one or more still or motion thermal images of an object, e.g., a solar panel. In addition, the UAV may carry a Lidar, radio transceiver, sonar, and traffic collision avoidance system (TCAS). Data collected by the devices may be stored on the device collecting the data, or the data may be stored on non-volatile memory 318 of the UAV primary computer system 300.

The UAV primary computer system 300 may be coupled to various radios, e.g., transceivers 359 for manual control of the UAV, and for wireless or wired data transmission to and from the UAV primary computer system 300, and optionally a UAV secondary computer system 302. The UAV may use one or more communications subsystems, such as a wireless communication or wired subsystem, to facilitate communication to and from the UAV. Wireless communication subsystems may include radio transceivers, infrared, optical ultrasonic and electromagnetic devices. Wired communication systems may include ports such as Ethernet ports, USB ports, serial ports, or other types of port to establish a wired connection to the UAV with other devices, such as a ground control station (GCS), flight planning system (FPS), or other devices, for example a mobile phone, tablet, personal computer, display monitor, other network-enabled devices. The UAV may use a lightweight tethered wire to a GCS for communication with the UAV. The tethered wire may be affixed to the UAV, for example via a magnetic coupler.

The UAV can generate flight data logs by reading various information from the UAV sensors and operating system 320 and storing the information in computer-readable media (e.g., non-volatile memory 318). The data logs may include a combination of various data, such as time, altitude, heading, ambient temperature, processor temperatures, pressure, battery level, fuel level, absolute or relative position, position coordinates (e.g., GPS coordinates), pitch, roll, yaw, ground speed, humidity level, velocity, acceleration, and contingency information. The foregoing is not meant to be limiting, and other data may be captured and stored in the flight data logs. The flight data logs may be stored on a removable medium. The medium can be installed on the ground control system or onboard the UAV. The data logs may be wirelessly transmitted to the ground control system or to the FPS.

Modules, programs or instructions for performing flight operations, contingency maneuvers, and other functions may be performed with operating system 320. In some implementations, the operating system 320 can be a real time operating system (RTOS), UNIX, LINUX, OS X, WINDOWS, ANDROID or other operating system 320. Additionally, other software modules and applications may run on the operating system 320, such as a flight control module 322, contingency module 324, inspection module 326, database module 328 and mission module 329. In particular, inspection module 326 can include computer instructions that, when executed by processor 335, can cause processor 335 to control the UAV to perform solar panel inspection operations as described below. Typically, flight critical functions will be performed using the UAV primary computer system 300. Operating system 320 may include instructions for handling basic system services and for performing hardware dependent tasks.

In addition to the UAV primary computer system 300, the secondary computer system 302 may be used to run another operating system 372 to perform other functions. The UAV secondary computer system 302 can be a system of one or more computers, or software executing on a system of one or more computers, which is in communication with, or maintains, one or more databases. The UAV secondary computer system 302 can include a processing subsystem 390 of one or more processors 394, GPU 392, and I/O subsystem 393. The UAV secondary computer system 302 can include logic circuits, analog circuits, associated volatile and/or non-volatile memory, associated input/output data ports, power ports, etc., and include one or more software processes executing on one or more processors or computers. The UAV secondary computer system 302 can include memory 370. Memory 370 may include non-volatile memory, such as one or more magnetic disk storage devices, solid-state hard drives, flash memory. Other volatile memory such a RAM, DRAM, SRAM may be used for storage of data while the UAV is operational.

Ideally, modules, applications and other functions running on the secondary computer system 302 will be non-critical functions in nature. If the function fails, the UAV will still be able to operate safely. The UAV secondary computer system 302 can include operating system 372. In some implementations, the operating system 372 can be based on real time operating system (RTOS), UNIX, LINUX, OS X, WINDOWS, ANDROID or other operating system.

Additionally, other software modules and applications may run on the operating system 372, such as an inspection module 374, database module 376, mission module 378 and contingency module 380. In particular, inspection module 374 can include computer instructions that, when executed by processor 394, can cause processor 394 to control the UAV to perform solar panel inspection operations as described below. Operating system 372 may include instructions for handling basic system services and for performing hardware dependent tasks.

The UAV can include controllers 346. Controllers 346 may be used to interact with and operate a payload device 348, and other devices such as cameras 349A and 349B. Cameras 349A and 349B can include a still-image camera, video camera, infrared camera, multispectral camera, stereo camera pair. In addition, controllers 346 may interact with a Lidar, radio transceiver, sonar, laser ranger, altimeter, TCAS, ADS-B (Automatic dependent surveillance-broadcast) transponder. Optionally, the secondary computer system 302 may have controllers to control payload devices.

The UAV 100 illustrated in FIGS. 1-3 is an example provided for illustrative purposes. The UAV 100 in accordance with the present disclosure may include more or fewer components than are shown. For example, while a quadcopter is illustrated, the UAV 100 is not limited to any particular UAV configuration and may include hexacopters, octocopters, fixed wing aircraft, or any other type of independently maneuverable aircraft, as will be apparent to those of skill in the art having the benefit of the disclosure herein. Furthermore, the navigation of an autonomous UAV 100 may be guided by other types of vehicles (e.g., spacecraft, land vehicles, watercraft, submarine vehicles, etc.).

The following paragraphs describe a drone deployment configuration generation system to determine an optimized drone deployment configuration. The system may be used to deploy drones such as the UAV 100 of FIGS. 1-3.

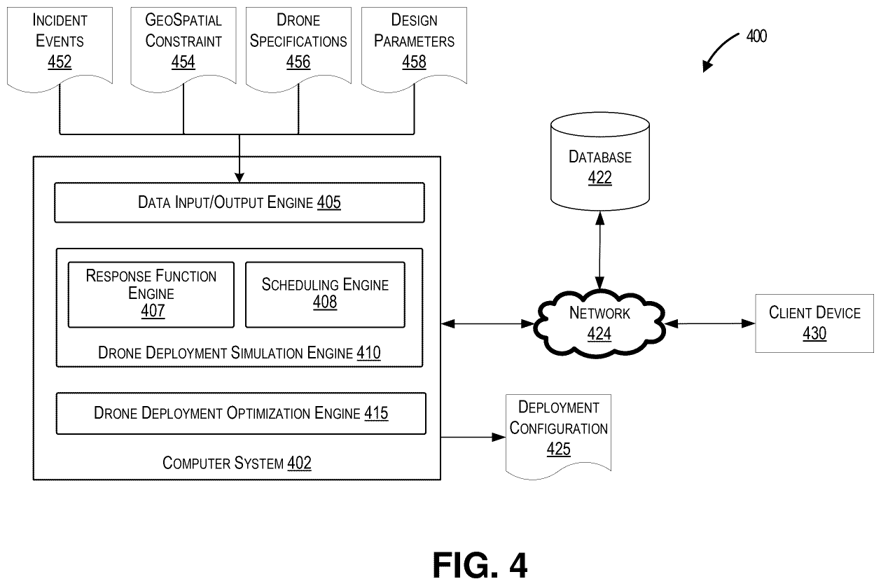

FIG. 4 illustrates a drone deployment configuration generation system 400, consistent with various embodiments. The system 400 includes a computer system 402 in communication with a database 422 and a client device 430 over a network 424. The computer system 402 is configured to simulate autonomous drone operations and determine optimized drone deployment configurations using multiple user-supplied inputs.

By the way of example, computer system 402 may include any computing device, such as a personal computer (PC), a laptop computer, a tablet computer, a hand-held computer, or other computer equipment. Computer system 402 may include data input/output (I/O) engine 405, drone deployment simulation engine 410, drone deployment optimization engine 415, or other components. The client device 430 may include any type of mobile terminal, fixed terminal, or other device. By way of example, client device 430 may include a desktop computer, a notebook computer, a tablet computer, a smartphone, a wearable device, or other client device. Users may, for instance, utilize one or more client devices 430 to interact with components of system 400.

A component of system 400 may communicate with one or more components of system 400 via a communication network 424 (e.g., Internet, a mobile phone network, a mobile voice or data network, a cable network, a public switched telephone network, or other types of communications network or combinations of communications networks). As an example, the client device 430 and the computer system 402 may communicate via the network 424. The communication network 424 may be a wireless or wired network.

It should be noted that, while one or more operations are described herein as being performed by particular components of computer system 402, those operations may, in some embodiments, be performed by other components of computer system 402 or other components of system 400. As an example, while one or more operations are described herein as being performed by components of computer system 402, those operations may, in some embodiments, be performed by components of client device 430.

It should be noted that, although some embodiments are described herein with respect to machine learning (ML) models, other prediction models (e.g., statistical models or other analytics models) may be used in lieu of or in addition to ML models in other embodiments (e.g., a statistical model replacing an ML model and a non-statistical model replacing a non-ML model in one or more embodiments).

The system 400 determines drone deployment configurations using simulation of autonomous drone operations under real-world constraints. The simulation engine 410 evaluates multiple drone deployment configurations based on real-world historical incident events data 452, drone specification data 456, and geospatial constraint data 454. The simulation engine 410 computes performance metrics including response time, energy-constrained on-station time, mission duration, and incident coverage levels. These performance metrics are evaluated against one or more design parameters 458 such as target coverage thresholds and target on-station time. The optimization engine 415 then determines a drone deployment configuration 425 that satisfies the design parameters 458. The drone deployment configuration 425 typically includes deployment parameters such as number of drone hives, drone hive geolocations, or drones per hive.

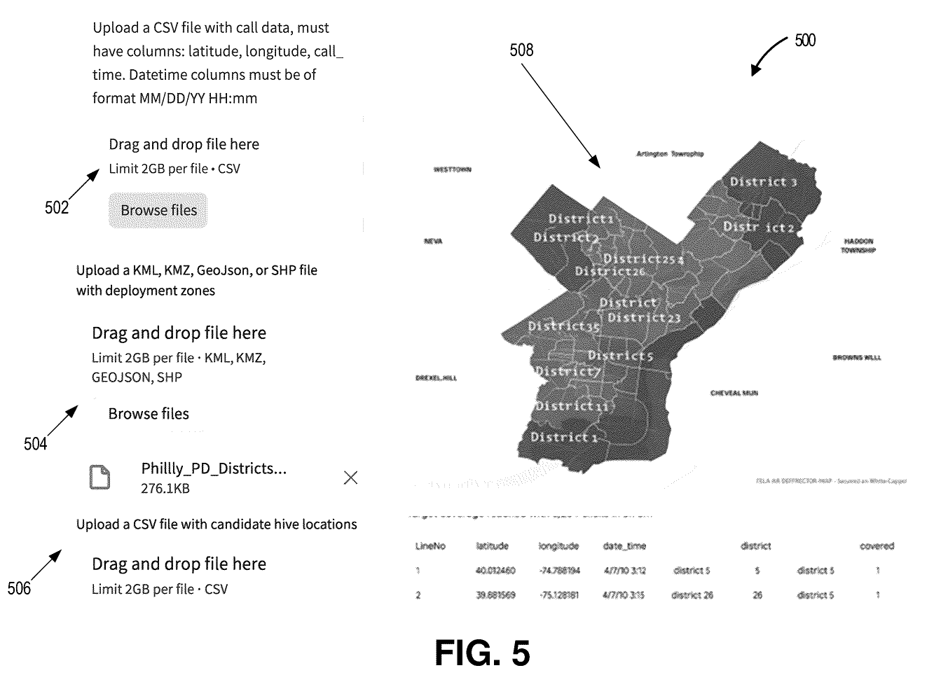

The system 400 may accept multiple categories of input data: incident event data 452, geospatial constraint data 454, drone specification data 456, and design parameters 458. These inputs may be provided via one or more graphical user interfaces (GUIs), such as the GUIs shown in FIGS. 5-7, using client device 430.

In some embodiments, incident event data 452 refers to historical or simulated records of events for which drone response is modeled. This data may be used to estimate response demand and evaluate coverage and timeliness across candidate deployment configurations. The incident event data 452 may include at least a timestamp of when the incident occurred and geospatial coordinates such as latitude and longitude of where the incident occurred. The incident event data 452 may also include the type of incident involved, a priority level associated with the incident, or the response time of traditional ground-based units for comparison. This data is typically uploaded via a GUI in any of various formats. In some embodiments, incident event data 452 is input in structured file formats such as CSV, for example, as shown in first GUI 500 of FIG. 5 and using first GUI element 502.

In some embodiments, the geospatial constraint data 454 defines operational, physical, or regulatory boundaries that govern where drones are permitted or restricted from operating. These constraints ensure that deployment simulations adhere to real-world airspace rules and operational limitations. The geospatial constraint data 454 may include definitions of permitted operating zones such as city districts or law enforcement jurisdictions, restricted areas such as no-fly zones around airports or sensitive infrastructure. The geospatial constraint data 454 may also include a list of user-preferred candidate locations for placing drone hives. These inputs may be provided in various ways. For example, the user may identify the operational, physical, or regulatory boundaries by interacting with a map of the geographical area generated in a GUI, such as the map 508 of first GUI 500. In another example, the user may input the data in various file formats such as KML, KMZ, SHP, or GeoJSON for zones, as depicted by second GUI element 504 in first GUI 500. In another example, the user may input candidate hive locations using file formats such as CSV, as depicted by third GUI element 506 in first GUI 500.

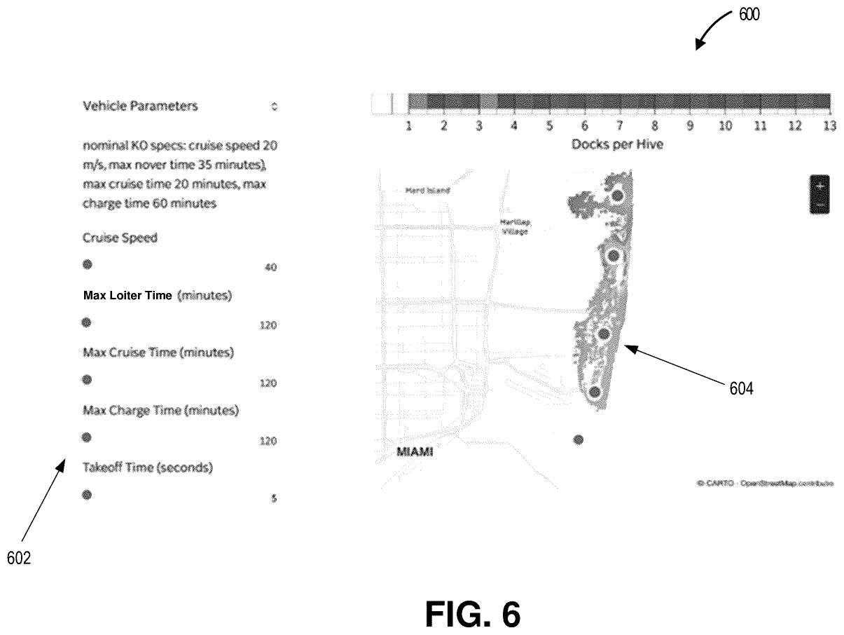

In some embodiments, drone specifications data 456 define operational characteristics of the drone platforms being simulated. These parameters are used to compute drone feasibility, mission duration, response time, and battery usage within the simulation environment. The drone specifications data 456 may include one or more of the drone's cruise speed, maximum loiter time, maximum cruise time, battery recharge time, or takeoff time. The user may input these specifications in a number of ways. For example, the user may input the specification by entering the numerical values or using a slider UI control, such as fourth GUI element 602 shown in second GUI 600 of FIG. 6.

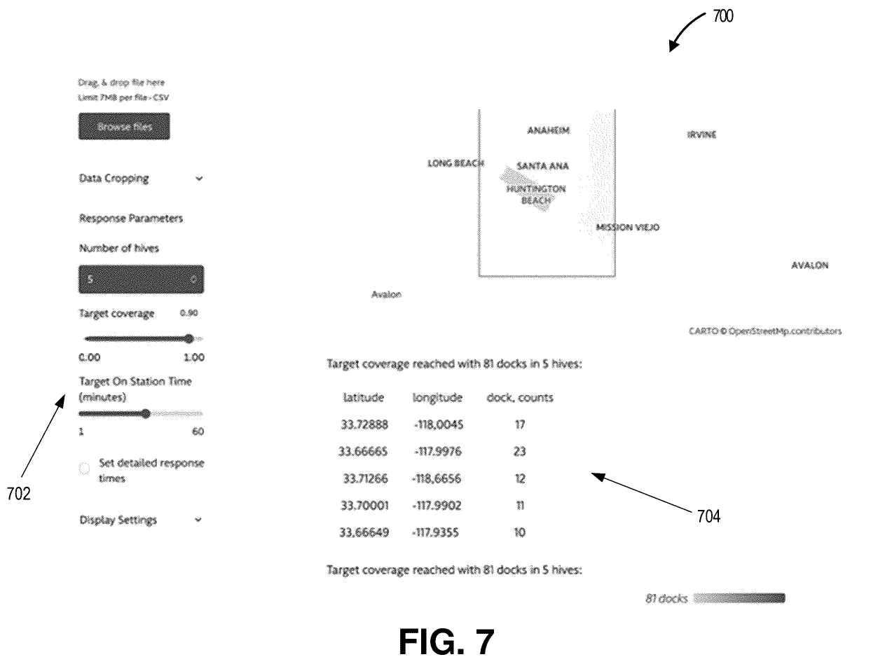

In some embodiments, design parameters 458 indicate deployment goals and evaluation criteria that are used by the optimization engine 415 to select or rank deployment configurations. These parameters define the operational objectives a deployment must satisfy in order to be considered valid. The design parameters 458 may include a target incident coverage level defined as a percentage of total incidents to be served, and a target on-station time indicating the minimum time a drone must remain over the incident location. The design parameters 458 may also include one or more of a specified or variable number of drone hives, the number of drones to be assigned per hive, a setting for whether hive locations are to be manually input or automatically generated, and one or more filters to select which incidents (e.g., based on type or priority, location etc.) are to be included in the simulation. The design parameters 458 may be input to the system 400 in various ways. For example, the design parameters 458 such as the target incident coverage level and the target on-station time may be input via numerical values or sliders, such as fifth GUI element 702 shown in third GUI 700 of FIG. 7.

The data I/O engine 405 may manage the data input or output. For example, the data I/O engine 405 may generate the appropriate GUIs, such as those illustrated in FIGS. 5-7, for the user to input the data. For example, first GUI 500 allows uploading of incident event data 452, geospatial constraint data 454, and candidate drone hive locations; second GUI 600 allows entry of drone specification data 456 including cruise speed, maximum loiter time, maximum cruise time, charge time, and takeoff time; and third GUI 700 enables definition of design parameters 458 such as the target coverage level and target on-station time. The data I/O engine 405 may also output data, such as the deployment configuration 425 selected by the optimization engine 415, for example, via a GUI (not illustrated). The data I/O engine 405 parses and formats the data for use in downstream simulation modules. The user may input the data using the client device 430, and the data I/O engine may store it in database 422.

The data I/O engine 405 may also initiate dataset filtering based on geospatial parameters to produce a filtered subset of incident data. For example, the user may prefer to run the simulation for a particular geographic location, incident event type, incident priority, etc. The data I/O engine 405 may provide such filters to the user, for example, via a GUI (not illustrated) and the user may apply one or more filters to the incident event data 452 to obtain a filtered data set.

A drone deployment simulation engine 410 performs the core simulation functions. The simulation engine 410 operates on multiple candidate deployment configurations. These configurations are generated by varying the number of drone hives and their respective geolocations. Each configuration may also vary the number of drones per hive. Each configuration may also determine the locations for drone hives. For example, a clustering algorithm, such as k-means, may be applied to the incident events data to determine candidate drone hive geolocations based on incident density and flight range constraints. In some embodiments, the hive geolocations may be determined using a ML model that is trained to determine hive geolocations based on various parameters such as incident density, drone specifications, geospatial constraints (e.g., where drones have to deployed, should not be deployed, etc.).

For each deployment configuration, the simulation engine 410 simulates the drone operation for each incident event from the incident event data 452 or the filtered incident events if the user has filtered the incident events, and computes the relevant performance metrics and coverage statistics. The performance metrics may include response time for an incident, energy-constrained on-station time for the incident, mission duration for the incident, and incident coverage levels, such as the percentage of incident events responded to by the drone for the particular deployment configuration.

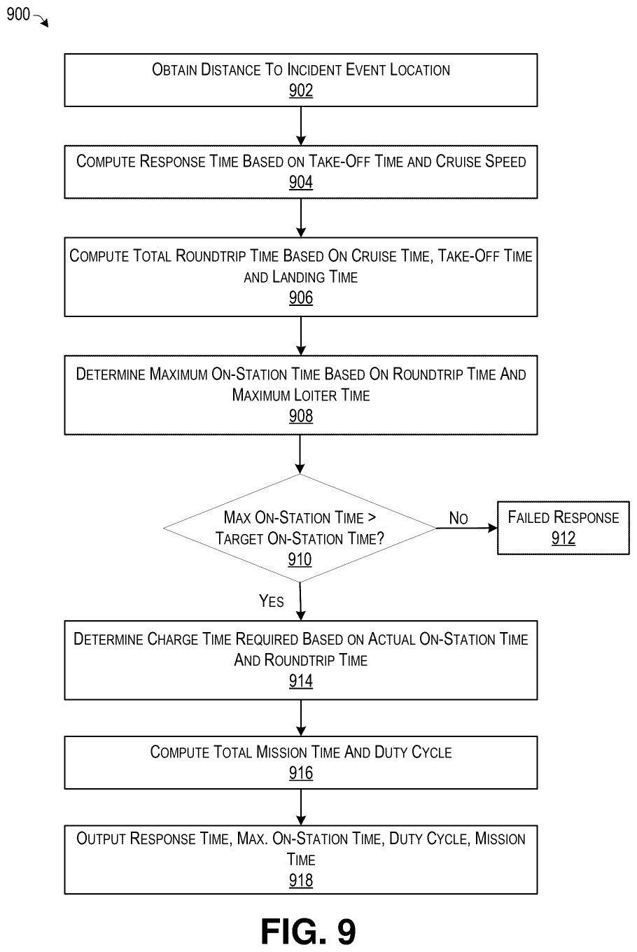

The simulation engine 410 includes a response function engine 407 and a scheduling engine 408 that facilitate the determination of one or more performance metrics. For example, the response function engine 407 determines performance metrics such as response time, energy-constrained on-station time, duty cycle, and mission duration for each incident in a given deployment configuration. The determinations are based on drone specifications 456 such as takeoff time, cruise speed, energy consumption profile, and range, along with the geographic distance to the incident locations. Additional details are described at least with reference to FIG. 9.

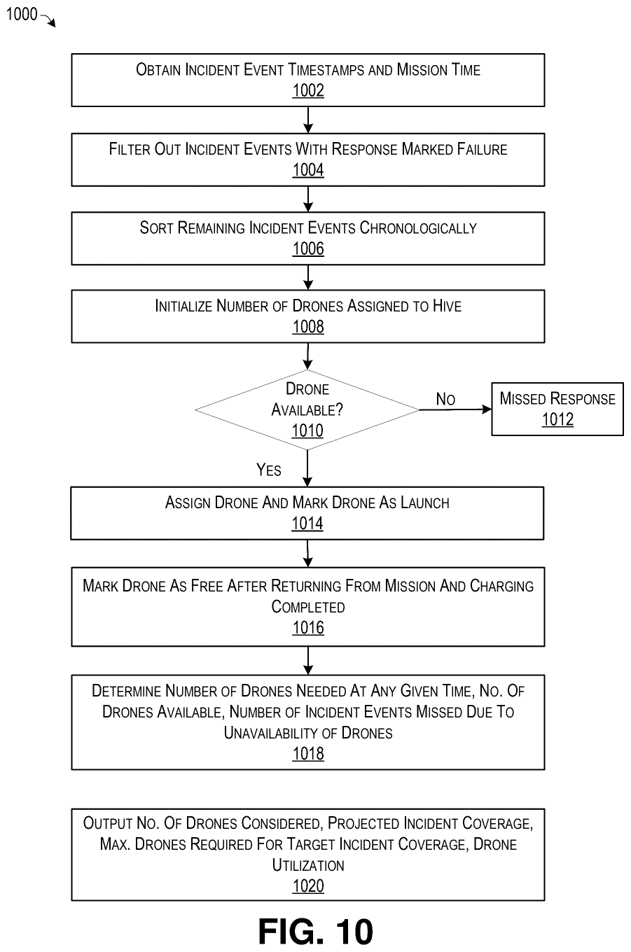

The scheduling engine 408 simulates drone availability and assignment over time using a timeline of launch and release events. This process enables computation of projected incident coverage for a given number of drones per hive. The engine determines which incidents can be covered given drone availability and how many drones are concurrently needed to avoid service delays. Additional details are described at least with reference to FIG. 10.

A drone deployment optimization engine 415 receives the simulation outputs (e.g., performance metrics) and evaluates whether the candidate deployment configurations satisfy the design parameters 458. The design parameters 458 may include one or more of a specified target coverage level, a specified target on-station time, or comparative performance thresholds such as drone response time being less than or equal to the historical response time of other response systems (e.g., ground-based units). For example, if the response time of the drone exceeds the response time of a ground-based unit, the optimization engine 415 may mark the incident event as a “failure.” If the drone's response time is lesser than that of the ground-based unit or below a specified threshold, the incident event may be marked as “success.” In another example, if a user-specified target on-station time is provided, the optimization engine 415 may compare the projected on-station time against the specified target on-station time. If the projected on-station time is less than the target on-station time, the incident event is marked as a failure; otherwise, it is marked as a success.

In some embodiments, the optimization engine 415 may determine the projected incident coverage level as a percentage of the incident events the drone has successfully responded to (e.g., incident events marked “success”). This projected coverage level is compared with the specified target coverage level to determine whether the deployment configuration is valid. For example, if the projected incident coverage level is lesser than the specified target coverage level, the optimization engine 415 marks the deployment configuration as “invalid”, else marks the deployment configuration as “valid.”

Accordingly, the optimization engine 415 may identify the valid deployment configuration. In some embodiments, if multiple deployment configurations are valid, the optimization engine 415 may rank configurations based on a weighted performance score that includes one or more parameters such as response latency, drone utilization, and the number of hives required.

The deployment configuration results are stored in a database 422 and made accessible through the client device 430 over the network 424. For example, the data I/O engine 405 may output the deployment configuration 425 selected by the optimization engine 415 to the client device 430 for display via a GUI. The deployment configuration 425 may include number of hives, hive geolocations and number of drones per hive. The deployment configuration 425 may be output in various formats. For example, the deployment geolocations of the hives may be shown on a map, such as map 604 of second GUI 600, where geolocations are indicated using dark circles. In another example, deployment configuration 425 may displayed as a table having geolocations and number of drones of each hive, as shown in table 704 of third GUI 700. In some embodiments, the output data may also include projected coverage levels and distribution heatmaps (not illustrated). In some embodiments, a distribution heat map (also referred to as drone utilization heatmap) may indicate areas with high concentrations of incident events, drone activity, or unserved regions. Such maps are used to identify geographic hotspots, underutilized areas, or coverage gaps. The distribution heat map can also illustrate where drones are frequently dispatched or where incidents remain unaddressed due to limited drone availability, the active and idle periods of each drone or hive over time. This visualization supports strategic placement of drone hives and adjustment of drone counts per hive to improve overall system performance. This visualization may be used to optimize resource distribution and detect underutilized deployment configurations.

While the above paragraphs describe the simulation engine 410 as generating multiple deployment configurations and simulating each of the configurations to select an optimized configuration, the simulation engine 410 may also simulate a user-specified deployment configuration. For example, the user may specify one or more of the number of drone hives, hive geolocations, or drones assigned per hive. The simulation engine 410 may simulate drone operation based on incident events data 452 or a filtered subset thereof, determine whether the user-specified configuration is valid or invalid, and output the validity determination.

The system 400 described in FIG. 4 enables simulation-based evaluation of drone deployment strategies under real-world constraints. The modular architecture, including distinct engines for data input, simulation, scheduling, and optimization, provides a flexible platform for planning autonomous drone deployments in public safety, logistics, or infrastructure monitoring applications.

The following paragraphs describe the GUIs used to input the data. The client device 430 may access the GUIs described in FIGS. 5 through 7 to upload input data, monitor simulation progress, and visualize optimized deployment configurations.

FIG. 5 illustrates first GUI 500 that allows a user to upload operational datasets required for autonomous drone deployment simulation, consistent with various embodiments. The GUI 500 is accessible through client device 430 and is designed to receive multiple categories of input: incident event data 452, geospatial constraint data 454, and candidate drone hive locations.

The first GUI element 502 provides an interface to upload incident event data 452 in CSV format. The incident event data 452 includes geolocation details such as latitude, longitude, and call time. These incident records represent historical or simulated event locations that form the basis for evaluating drone response scenarios.

The second GUI element 504 supports the upload of geospatial constraint data 454 in geospatial formats such as keyhole markup language (KML), keyhole markup language zipped (KMZ), geographic JavaScript object notation (GeoJSON), or shapefile (SHP). These files define deployment boundaries, restricted airspace, or no-fly zones. This data constrains where drones are allowed to fly or where deployment infrastructure may be located.

The third GUI element 506 provides an option to upload candidate drone hive locations. These locations may be supplied by the user or derived from external datasets and define potential positions for docking stations or launch points. The hive locations uploaded here serve as inputs for the generation of candidate deployment configurations simulated in the simulation engine 410, as described in FIG. 4.

A map visualization 508 on the right-hand portion of first GUI 500 displays the uploaded geographic zones, such as drone operating sectors (light colored zones). The map allows users to verify spatial alignment between the incident data, constraint zones, and potential hive locations.

The first GUI 500 facilitates seamless data ingestion into the system 400 and supports filtering and localization of the deployment configuration planning process based on real-world operational environments.

FIG. 6 illustrates second GUI 600 that enables a user to specify drone specification parameters, consistent with various embodiments. These parameters are used by the simulation engine 410 to compute per-incident performance metrics including response time, energy-constrained on-station time, mission duration, or duty cycle.

The fourth GUI element 602 provides interactive sliders and fields for setting drone specifications data 456. These specifications include cruise speed, maximum loiter time, maximum cruise time, battery charge time, and takeoff time. These values may be nominal for a given drone model or varied to simulate different platform capabilities.

In some embodiments, the cruise speed affects the drone's travel time to an incident site. The maximum loiter time determines how long the drone can remain on-station once it arrives. The maximum cruise time and charge time together may determine whether the drone can complete a mission and how soon it may be redeployed. The takeoff time impacts response latency. All of these variables are inputs to the response function engine 407 and the scheduling engine 409 described in FIG. 4.

To the right of the specification panel is a geographic map 604 view displaying hive deployment zones. The input values from second GUI 600 may be used in computing the feasibility and efficiency of candidate drone deployment configurations under simulation.

FIG. 7 illustrates third GUI 700 for inputting design parameters and reviewing simulation results for autonomous drone deployment planning, consistent with various embodiments. The third GUI 700 allows a user to define operational goals that will be used by the optimization engine 415 to evaluate drone deployment configurations.

The fifth GUI element 702 provides fields and controls for defining response objectives. These include setting the number of desired drone hives, specifying a target coverage level, and specifying a target on-station time. The number of hives are optional, and if provided, dictates how many deployment clusters will be evaluated. If the number of hives are not provided by the user, simulation engine 410 may automatically determine the number of hives. The target coverage level defines the percentage of incident events that must be served by the drone fleet. The target on-station time represents the required duration that a drone must remain present at the incident location to fulfill mission objectives. These parameters are received by simulation engine 410 and optimization engine 415. Each candidate configuration is simulated to assess whether these criteria are met.

To the right of third GUI 700, a geographic map presents the simulation output, including hive locations and dock counts per hive. Below the map, a table 704 shows the latitude and longitude coordinates of the selected hives along with the number of drones assigned to each hive. This third GUI 700 supports evaluation of how well simulated deployment configurations meet predefined mission requirements and allows users to interactively iterate through parameter choices to achieve optimal deployment strategies.

In some embodiments, the GUI 700 includes drag-and-drop tools, click-to-select deployment sites, and drawing tools for user-defined exclusion zones. Upon user changes to feasible hive inputs, the system automatically triggers a recomputation pipeline. Visual overlays update to reflect changes in response zones, coverage gaps, and feasibility metrics. Failed or infeasible response areas are color-coded to aid user correction and decision making. The visual (or output) overlays may include, but are not limited to, one or more of: incident response arcs (based on flight time and radius), ranked hive location lists sorted by coverage contribution, coverage histograms comparing candidate configurations, drone idle/active utilization charts, and exportable CSV or shapefile for integration into external GIS tools.

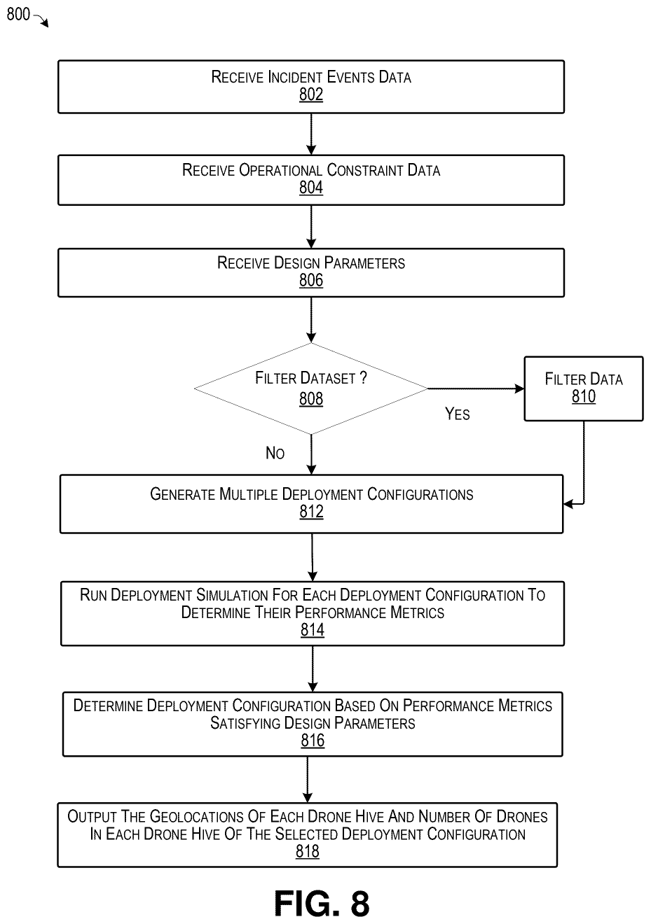

FIG. 8 illustrates a flow diagram of method 800 for simulating and optimizing drone deployment configurations, consistent with various embodiments. The method 800 may be implemented in the system 400 of FIG. 4.

At block 802, the data I/O engine 405 receives incident events data, such as incident events data 452. This data includes geospatial coordinates, timestamps, and other attributes of incident records as described at least with reference to FIGS. 4 and 5. For example, the incident events data 452 can include call records of an emergency response system (such as calls to a 911 operator).

At block 804, the data I/O engine 405 receives operational constraint data. In some embodiments, the operational constraints data includes geospatial constraints data 454, such as permitted operating zones and no-fly areas, optionally candidate hive locations, as shown in FIG. 5. The operational constraint data also includes drone specifications data 456. The drone specifications data 456 may include one or more of the drone's cruise speed, maximum loiter time, maximum cruise time, battery recharge time, or takeoff time.

At block 806, the data I/O engine 405 receives design parameters, such as design parameters 458, as described in FIG. 7. The design parameters 458 may include a target coverage level defined as a percentage of total incidents to be served, and a target on-station time indicating the minimum time a drone must remain over the incident location. The design parameters 458 may also include one or more of a specified or variable number of drone hives, the number of drones to be assigned per hive, a setting for whether hive locations are to be manually input or automatically generated, and one or more filters to select which incidents (e.g., based on type or priority, location etc.) are to be included in the simulation.

At determination block 808, a determination is made whether to filter the dataset of incident events data 452 based on user-defined criteria. If filtering is indicated (e.g., by a user), at block 810, the data I/O engine 405 executes a filtering process, for example, by geographic region, incident type, incident priority etc. to yield a filtered dataset. If filtering is not indicated, the method proceeds to block 812.

At block 812, simulation engine 410 generates multiple candidate drone deployment configurations. In some embodiments, the candidate configurations are generated by varying one or more of the number of hives, their geolocations, and number of drones per hive. For example, a first candidate deployment configuration can have five drone hives spread over a first set of geolocations with each hive having varied number of drones (e.g., in a range of fifteen to twenty five drones per hive), a second candidate deployment configuration can have seven drone hives spread over a second set of geolocations, with each hive having the same number of drones (e.g., twenty two drones per hive), a third candidate deployment configuration can have five drone hives spread over a third set of geolocations with each hive having the same number of drones (e.g., fifteen drones per hive) and so on. In some embodiments, the simulation engine 410 may determine the hive geolocations, number of hives, or number of drones per hive automatically. If the user has provided the hive geolocations, number of hives, or number of drones per hive, the simulation engine 410 may use the user-specified data.

At block 814, simulation engine 410 simulates drone operations for each candidate configuration to compute associated performance metrics, as described at least with reference to FIG. 4. The performance metrics include per-incident performance metrics such as response time, energy-constrained on-station time, duty cycle, and mission duration. Some of the performance metrics may be determined based on the drone specifications data 456. In some embodiments, the response time refers to the duration between initiation of drone dispatch and the arrival of the drone at the incident location. The response time may be determined based on the distance to the incident location, the drone's cruise speed and the take-off time. In some embodiments, the on-station time refers to the maximum duration a drone is capable of remaining at the incident location before returning, constrained by the drone's energy reserves and total mission time. In some embodiments, the mission duration refers to the total time from drone launch to its return and readiness for redeployment. The mission duration may include outbound and return cruise times, take-off and landing times, on-station time, and battery recharge time. In some embodiments, the duty cycle refers to the ratio of the on-station time to the mission duration, excluding battery recharge time. This metric reflects how effectively the drone utilizes its active flight time to perform on-site tasks.

The performance metric may also include per-deployment configuration performance metric, such as projected incident coverage level, which is a percentage of incident events served by the drone fleet. Some of these metrics may be generated using the response function engine 407 and scheduling engine 408, described in further detail with respect to FIGS. 9 and 10.

At block 816, optimization engine 415 evaluates the performance metrics against the design parameters 458 to determine which configurations are valid or optimal. For example, if the response time of the drone exceeds the response time of a ground-based unit, the optimization engine 415 may mark the incident event as a “failure”; otherwise as “success.” In another example, if the projected on-station time is less than the target on-station time, the incident event is marked as a failure; otherwise, it is marked as a success. The optimization engine 415 may determine the projected incident coverage level as a percentage of the incident events the drone has successfully responded to (e.g., incident events marked “success”). If the projected incident coverage level is lesser than the specified target coverage level, the optimization engine 415 marks the deployment configuration as “invalid”, else marks the deployment configuration as “valid.” If multiple configurations are determined to be valid, selection may be based on ranked performance scores. The optimization engine 415 may select the most optimal (highest ranked) deployment configuration, e.g., deployment configuration 425.

At block 818, the data I/O engine 405 outputs the details such as geolocations of the drone hives and the number of drones assigned to each hive for the configuration selected by the optimization engine 415. In some embodiments, the data I/O engine 405 may output the details of the deployment configuration 425 to a GUI, such as third GUI 700, which may be accessed by a user through client device 430.

In some embodiments, the blocks 814 and 816 may be executed iteratively, e.g., for each deployment configuration.

FIG. 9 illustrates a flow diagram of method 900 for computing performance metrics of a deployment configuration, consistent with various embodiments. In some embodiments, the method 900 may be implemented in simulation engine 410 of FIG. 4 and may be executed as part of block 814 of method 800. Further, the method 900 may be executed for each incident event.

At block 902, the distance from a drone hive to the incident event location is obtained. This distance serves as a baseline for computing travel time and energy consumption.

At block 904, the response function engine 407 computes the response time based on takeoff time and cruise speed of the drone, which are obtained as part of the drone specifications data 456.

At block 906, the response function engine 407 computes the total roundtrip time (e.g., from dock location to incident location and back) based on cruise time, takeoff time, and landing time. While the take-off time and landing time are obtained from drone specifications data 456, the cruise time may be derived based on the distance and the cruise speed.

At block 908, the response function engine 407 determines the maximum possible on-station time by subtracting the roundtrip time from the drone's total allowable mission time (excluding charging time), as governed by its maximum loiter capability.

At determination block 910, the response function engine 407 evaluates whether the calculated maximum on-station time meets or exceeds the target on-station time provided in the design parameters 458. If not, the process branches to block 912, marking the incident event as a failed response. If the target is met, at block 914, the response function engine 407 computes the charge time needed to recover battery based on the roundtrip duration and the actual on-station time.

At block 916, the response function engine 407 computes the total mission time and duty cycle, reflecting how frequently the drone can be reused. As described above, the mission time may include outbound and return cruise times, take-off and landing times, calculated on-station time, and battery recharge time. The duty cycle refers to the ratio of the on-station time to the mission time, excluding battery recharge time.

At block 918, the response function engine 407 outputs the performance metrics including response time, maximum on-station time, duty cycle, and total mission duration.

In some implementations, if a given drone deployment configuration cannot satisfy incident requirements—due to battery limitations, flight range, or response time—the system may mark that event as a “failure.” These failures can be logged per-incident, aggregated per hive, and visualized on the GUI as red or cross-hatched overlays. This enables planners to identify infeasible regions or revise input parameters accordingly.

FIG. 10 illustrates a flow diagram of method 1000 for computing the incident coverage level relative to drone availability, consistent with various embodiments. In some embodiments, the method 1000 may be implemented in simulation engine 410 of FIG. 4 and may be executed as part of block 814 of method 800. Further, the method 1000 may be executed for each incident event. This method models temporal availability and task allocation to determine how many drones are required for a given target coverage level. The assignment of drones to incident events is modeled using a scheduling algorithm that simulates drone availability over time, based on launch and mission duration data.

At block 1002, the scheduling engine 408 obtains incident event timestamps and corresponding mission durations. In some embodiments, the incident event timestamps are obtained from the incident events data 452 and the corresponding mission durations are obtained from the response function engine 407.

At block 1004, the scheduling engine 408 filters out the incident events which have already been marked failure, as determined based on performance metrics computed by the response function engine 407 described in FIG. 9 and as described at least with reference to block 816 of FIG. 8.

At block 1006, the scheduling engine 408 sorts the remaining incident events chronologically.

At block 1008, the scheduling engine 408 initializes the number of drones assigned to each hive. The number of drones per hive may be user-specified or determined by simulation engine 410, as described at least with reference to FIG. 8.

At determination block 1010, the scheduling engine 408 checks drone availability for each incident in sequence. If a drone is not available, at block 1012, the scheduling engine 408 marks the incident event as a missed response. If a drone is available, at block 1014, the scheduling engine 408 assigns the drone and marks the event as “launch.” The count of available drones is decreased by “1.”

At block 1016, the scheduling engine 408 marks the drone as “free” indicating the drone is available again once the mission and charging cycle is completed. The count of drones available is incremented by “1.”

At block 1018, the scheduling engine 408 analyzes the simulation log to determine the maximum number of drones needed at any point, number of drones available, number of incident events missed due to drone unavailability, and drone utilization. In some embodiments, drone utilization is defined as the ratio of the total time a drone is engaged in active mission operations (including takeoff, cruise, on-station, and return flight) to the total simulation period during which the drone is operational, excluding battery recharge time.

At block 1020, the scheduling engine 408 outputs performance metrics such as the number of drones considered, projected incident coverage, peak drone requirements for full coverage, and overall utilization. This output informs the optimization engine 415 when selecting an appropriate drone count per hive.

In some embodiments, the blocks 1008 to 1020 may be executed iteratively for different number of drones, with each iteration corresponding to a specified drone count.

In some embodiments, the autonomous drone deployment system 400 optionally computes incident density over time (e.g., hourly, daily, weekly trends) and uses this temporal information to determine the number of drones needed per hive to maintain real-time coverage. Heatmaps and line charts may reflect drone utilization, idle periods, or surge demand risk by time segment.

In some embodiments, the autonomous drone deployment system 400 may be configured to automatically determine the number of drone hives needed to achieve a specified target response time cumulative distribution function (CDF). The system 400 may also incorporate wireless communication considerations in the simulation and optimization process. These considerations may include the maximum number of drone docks permitted at a given location, the wireless base station coverage for connectivity to each drone hive, and the presence or absence of line of sight for communication or control.

The system 400 may further compute predicted operational and societal impact metrics based on statistical models. These impact metrics may include estimated monetary savings, reductions in violent incidents, reductions in total shootings, and reductions in officer-involved shootings. These estimates may be based on known data relating to how drones reduce the use of force, increase efficiency by minimizing officer travel time to low-priority incidents, or improve incident response times.

In some implementations, the system 400 may provide a preview capability that outputs a rough order-of-magnitude estimate based on limited inputs such as the city name and population density. This preview functionality may help users understand the potential benefits of drone deployment in a geographic area without requiring detailed data inputs. Additionally, the system may include a preview engine that uses pre-modeled urban parameters, population density proxies, or jurisdictional templates to generate baseline deployment configurations. In some implementations, these previews may be overlaid on the GUI and flagged as estimation-only results until refined by actual incident records or geospatial constraints.

In other implementations, the system may receive a list of candidate addresses for drone deployment and, based on the results of a simulation, automatically select the closest feasible locations relative to the optimally determined hive locations from the simulation.

The system 400 may be applied to various domains, e.g., operational scenarios beyond public safety or emergency response. In some embodiments, an asset owner or operator may upload records of service incidents, such as infrastructure inspections or equipment outages, along with geospatial locations of relevant assets. The system 400 may then be used to design and evaluate autonomous drone deployments to support service or inspection missions.

In one example, an energy utility provider may upload the locations of substations, transmission corridors, and distribution infrastructure. The system may generate a drone deployment configuration that enables regular inspection of all infrastructure elements at a specified frequency or supports incident response within a service-level agreement.

In another example, a transportation operator, such as a rail or transit agency, may upload the geospatial layout of rail lines, stations, and depots, along with historical or forecasted incident data. The system may be used to determine drone hive locations that enable timely inspection or incident coverage along the transportation network.

In another example, a fire department may input the locations of fire stations along with historical fire incidents or risk indicators based on population density, infrastructure type, building age, or vegetation data. The simulation engine 410 may then generate deployment plans that optimize drone coverage for fire-prone zones.

In some implementations, simulation engine 410 may include a hybrid deployment planning model. For example, first, an unsupervised clustering algorithm (e.g., k-means, DBSCAN, hierarchical) generates theoretical optimal hive placements. Then, a user constrains viable addresses or infrastructure zones via GUI. The system recomputes projected coverage and ranks proximity-based fallback sites. This hybrid model balances mathematical optimization with real-world feasibility constraints.

In another example, operators of large government facilities may upload perimeter boundaries, locations of critical assets, and time-based inspection schedules. The system 400 may evaluate drone deployments that ensure persistent coverage for inspection and security tasks across the facility's area of operation.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately)) 225°. The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

As used herein, unless specifically stated otherwise, the term “or” encompasses all possible combinations, except where infeasible. For example, if it is stated that a component includes A or B, then, unless specifically stated otherwise or infeasible, the component may include only A, or only B, or A and B. As a second example, if it is stated that a component includes A, B, or C, then, unless specifically stated otherwise or infeasible, the component may include only A, or only B, or only C, or A and B, or A and C, or B and C, or A and B and C. Expressions such as “at least one of” do not necessarily modify an entirety of a following list and do not necessarily modify each member of the list, such that “at least one of A, B, and C” should be understood as including only A, or only B, or only C, or any combination of A, B, and C. The phrase “one of A and B” or “any one of A and B” shall be interpreted in the broadest sense to include one of A, or one of B.

The descriptions herein are intended to be illustrative, not limiting. Thus, it will be apparent to one skilled in the art that modifications may be made as described without departing from the scope of the claims set out below.

The present techniques will be better understood with reference to the following enumerated embodiments:

1. A computer-implemented method for simulating autonomous drone deployment configurations, comprising:
receiving incident event data including timestamps and geospatial coordinates;
receiving geospatial constraint data defining permitted operating zones and restricted areas;
receiving drone specifications and design parameters including a target coverage level;
generating candidate drone deployment configurations by varying hive geolocations and drone assignments;
executing a simulation engine for each configuration to compute response time, on-station time, mission duration, and projected incident coverage; and
selecting a deployment configuration that satisfies the target coverage level based on the computed performance metrics.
   2. The method of the preceding embodiment, wherein executing the simulation engine includes computing a response time for each incident event based on a drone's takeoff time, cruise speed, and distance to the incident location.
   3. The method of any of the preceding embodiments, wherein computing on-station time includes deducting roundtrip cruise time and energy expenditure from the drone's maximum mission time.
   4. The method of any of the preceding embodiments, wherein drone specifications include cruise speed, takeoff time, battery charge time, and maximum loiter duration.
   5. The method of any of the preceding embodiments, wherein projected incident coverage is calculated as the percentage of incident events for which drones are available and capable of meeting both response time and on-station time requirements.
   6. The method of any of the preceding embodiments, further comprising generating a distribution heat map indicating high-density incident areas and drone activity zones.
   7. The method of any of the preceding embodiments, wherein the scheduling simulation computes drone availability using a timeline of launch and free events to allocate drones dynamically.
   8. The method of any of the preceding embodiments, further comprising outputting a graphical overlay of hive locations and incident response zones on a geographic map.
   9. A system for simulating and evaluating autonomous drone deployments, comprising:
a memory storing instructions and input datasets; and
one or more processors configured to:
   receive incident event data and geospatial constraints,
   simulate drone responses based on drone specifications and operational parameters,
   compute performance metrics including coverage level, and
   output a deployment configuration that meets a user-defined target coverage level.
      10. The system of any of the preceding embodiments, wherein the simulation includes a scheduling engine that simulates drone assignments using launch and release events to determine drone availability over time.
      11. The system of any of the preceding embodiments, wherein drone utilization is computed as the ratio of total active mission time to total operational time excluding recharge intervals.
      12. The system of any of the preceding embodiments, wherein the simulation engine compares computed response time with a historical response time of ground-based units and marks the incident as a success or failure accordingly.
      13. The system of any of the preceding embodiments, wherein the simulation engine filters incident event data based on user-defined constraints prior to executing the simulation.
      14. The system of any of the preceding embodiments, wherein a response function engine computes mission feasibility by comparing energy-constrained on-station time to a required dwell time.
      15. The system of any of the preceding embodiments, wherein the simulation engine generates multiple candidate configurations by varying the number of drone hives and combinations of hive geolocations.
      16. A non-transitory computer-readable medium storing instructions that, when executed, cause a processing system to perform operations comprising:
obtaining incident event data and geospatial constraints;
receiving drone specifications and user-defined design parameters;
executing a simulation engine to compute response metrics for multiple deployment configurations;
ranking the configurations based on response time, incident coverage, and drone utilization; and
outputting an optimal configuration that satisfies the design parameters.
   17. The medium of any of the preceding embodiments, wherein the simulation includes evaluating whether each configuration meets a minimum cumulative distribution threshold for response time.
   18. The medium of any of the preceding embodiments, wherein the simulation engine evaluates configurations using a weighted scoring function that includes drone utilization, mission success rate, and number of drone hives required.
   19. The medium of any of the preceding embodiments, wherein the simulation engine accepts user-defined hive locations and simulates the user-specified configuration for performance analysis.
   20. The medium of any of the preceding embodiments, wherein the simulation engine determines whether to mark each incident event as a success or failure based on comparison between simulated metrics and user-defined thresholds.
   21. A computer-implemented method for simulating and optimizing autonomous drone deployments, the method comprising:
receiving, via a graphical user interface, a historical dataset of incident events, wherein each incident event includes at least a timestamp and geospatial location;
receiving geospatial constraint data comprising at least one of operational boundaries, drone-restricted areas, or candidate deployment locations;
receiving one or more design parameters including a target coverage level, drone vehicle performance specifications, and incident filtering criteria;
generating a plurality of candidate drone deployment configurations by varying a number of drone hives and their geolocations;
executing a drone deployment simulation engine for each candidate configuration to compute, for each incident event, performance metrics including response time, energy-constrained on-station time, mission duration, and duty cycle;
evaluating the computed performance metrics to determine whether each candidate configuration satisfies the design parameters; and
outputting a selected drone deployment configuration including drone hive geolocations, drone counts per hive, and expected coverage performance metrics.
   22. The computer-implemented method of any of the preceding embodiments, wherein executing the drone deployment simulation engine comprises:
   calculating, for each incident event, a response function that determines drone response time, energy-constrained on-station time, duty cycle, and mission duration based on the drone specifications and geographic distance to the incident location.
   23. The computer-implemented method of any of the preceding embodiments, wherein executing the drone deployment simulation engine further comprises:
computing, for each candidate deployment configuration, a number of calls covered versus number of drones function by simulating drone assignment availability over time using launch and release events to determine call coverage percentages.
   24. A system for configuring autonomous drone deployments for responding to incident events, comprising:
at least one processor and a memory storing instructions that, when executed, cause the processor to:
   receive a dataset of incident events including timestamps and geospatial coordinates;
   receive geospatial constraint data comprising at least one of permitted drone operating zones or restricted airspace regions;
   receive design parameters including a target incident coverage level and drone mission constraints;
   for each of a plurality of candidate drone deployment configurations:
      execute a drone deployment simulation engine to compute, for each incident, performance metrics including flight path, energy-constrained on-station time, and mission duration based on the geospatial constraint data and drone specifications;
      evaluate the performance metrics for the candidate configuration using a deployment optimization engine to determine whether it satisfies the design parameters while complying with the geospatial constraint data; and
   output a selected drone deployment configuration including drone hive geolocations, number of drones per hive, and expected response performance metrics.
      25. The system of any of the preceding embodiments, wherein the drone deployment simulation engine is configured to calculate a response function for each incident based on drone flight parameters and geographic distance to determine response time, energy-constrained on-station time, and mission duration.
      26. The system of any of the preceding embodiments, wherein the drone deployment simulation engine is further configured to compute a calls-covered versus number-of-drones function by simulating temporal drone availability and call assignment to determine configuration-specific call coverage percentages.
      27. A non-transitory computer-readable medium storing instructions that, when executed by one or more processors, cause a processing system to perform operations comprising: obtaining incident event data including timestamps and geospatial coordinates;
obtaining geospatial constraint data comprising drone-restricted zones and candidate drone hive locations;
receiving design parameters including a target coverage level and drone specifications;
executing a simulation engine to compute, for each incident, projected response metrics including drone travel time, energy-constrained on-station time, and incident coverage status based on the geospatial constraint data and design parameters;
generating a plurality of candidate drone deployment configurations by applying clustering and scheduling algorithms to the candidate drone hive locations;
evaluating each configuration to determine whether the projected metrics satisfy the target coverage level;
outputting the selected deployment configuration including drone hive geolocations, drone counts per hive, and the projected response metrics.
   28. The computer-readable medium of any of the preceding embodiments, wherein the simulation engine further computes, for each incident, a response function based on drone performance specifications and incident distance to determine mission feasibility metrics.
   29. The computer-readable medium of any of the preceding embodiments, wherein the simulation engine further simulates a timeline of drone assignment and availability to determine a mapping between number of drones and call coverage percentage across candidate deployment configurations.
   30. A tangible, non-transitory, machine-readable medium storing instructions that, when executed by a data processing apparatus, cause the data processing apparatus to perform operations comprising those of any of embodiments 1-29.
   31. A system comprising: one or more processors; and memory storing instructions that, when executed by the processors, cause the processors to effectuate operations comprising those of any of embodiments 1-29.
   32. A system comprising means for performing any of embodiments 1-29.
   33. A computer-implemented method for estimating drone deployment configuration, comprising:
receiving, via a graphical user interface, one or more high-level inputs comprising at least a city name, a geographic boundary, or a population density value;
determining, based on a preconfigured estimation model, a number of drone hives, candidate hive geolocations, and a number of drones per hive for the geographic boundary;
estimating a projected incident coverage level based on the determined drone hives and drone counts; and
presenting, via the graphical user interface, the estimated number of drone hives, hive geolocations, drone counts, and the projected incident coverage level as a preview configuration.
   34. The method of claim 33, wherein the estimation model includes city-specific incident density parameters stored in a database.
   35. The method of claim 33, wherein the graphical user interface allows export of the preview configuration in a machine-readable format.

### Interactive Constraint and Recompute Interface

36. A system for interactive drone deployment planning, comprising:
a graphical user interface configured to display geospatial incident data and one or more machine-suggested hive geolocations on a geographic map;
a constraint input module configured to receive user selections modifying the hive geolocations to reflect feasible deployment locations; and
a recomputation engine configured to simulate, in response to the user selections, a drone deployment configuration and update one or more performance metrics including incident coverage level and response time.
   37. The system of claim 36, wherein the graphical user interface includes drag-and-drop tools for manual adjustment of hive geolocations.
   38. The system of claim 36, wherein the updated performance metrics include a histogram of incident response time distributions and a table of drone counts per hive.

### Mission Failure Tagging and Visualization

39. A method for visualizing drone deployment failures, comprising:
computing, for each incident event and a candidate drone deployment configuration, a response time and on-station time;
determining, based on a comparison of the computed response time and on-station time to respective threshold values, whether the incident event is infeasible;
tagging the infeasible incident event as a failed response; and
displaying, via a graphical user interface, the failed response incident event using a visually distinct marker.
   40. The method of claim 39, wherein the threshold values include a user-specified maximum response time and minimum on-station time.
   41. The method of claim 39, wherein the visually distinct marker comprises a red overlay, cross-hatching, or iconographic indicator on a map display.

### Cross-Domain Deployment Architecture

42. A system for simulating autonomous drone deployments across multiple operational domains, comprising:
a simulation engine configured to receive incident data comprising timestamps and geospatial coordinates, wherein the incident data corresponds to one or more of: public safety response, infrastructure maintenance, transportation service outages, or perimeter security alerts;
an optimization engine configured to evaluate drone deployment configurations based on domain-specific performance metrics; and
a graphical output module configured to present a selected deployment configuration comprising drone hive geolocations, drone counts per hive, and estimated incident coverage level.
   43. The system of claim 42, wherein the performance metrics include one or more of: service-level agreement compliance, coverage percentage, or inspection interval satisfaction.
   44. The system of claim 42, wherein the simulation engine is configured to adapt incident filtering parameters based on the selected operational domain.

### Temporal Load and Scheduling Density

45. A computer-implemented method for determining temporal drone demand, comprising: receiving incident event data comprising timestamps;
segmenting the incident event data into time intervals;
simulating drone availability and mission feasibility for each time interval;
computing, for each interval, a number of concurrently active drones required to satisfy a target incident coverage level; and
outputting a time-based drone demand profile across the segmented intervals.
   46. The method of claim 45, wherein the time intervals are hourly, daily, or weekly intervals.
   47. The method of claim 45, further comprising generating a heatmap visualizing the drone demand profile across a geographic area over time.

What is claimed is:

1. A computer-implemented method for generating drone deployment configuration using simulation of autonomous drone operations, the method comprising:
receiving, via a first graphical user interface (GUI), a dataset of incident events, wherein each incident event includes at least a timestamp and geospatial location;
receiving operational constraint data including geospatial constraint data, wherein the geospatial constraint data includes at least one of operational boundaries, drone-restricted areas, or candidate deployment locations;
executing a drone deployment simulation engine to compute, for each of multiple drone deployment configurations, performance metrics including at least a response time, an energy-constrained on-station time for responding drones and a projected incident coverage level based on the operational constraint data; and
determining, using a drone deployment optimization engine, a drone deployment configuration with the projected incident coverage level that satisfies a specified target coverage level, wherein the drone deployment configuration includes a set of drone hive geolocations.

2. The computer-implemented method of claim 1, wherein the operational constraint data includes drone specifications, the drone specifications including at least one of: take-off time, maximum cruise time, maximum loiter time, maximum cruise speed, or maximum battery recharge time.

3. The computer-implemented method of claim 2, wherein executing the drone deployment simulation engine includes:
computing, for each incident event in each drone deployment configuration, a response function that determines the performance metrics including the response time, the energy-constrained on-station time, a duty cycle, and a mission duration based on the drone specifications and a geographic distance to the geospatial location of an incident event.

4. The computer-implemented method of claim 1, wherein the drone deployment simulation engine computes the energy-constrained on-station time based on residual battery energy after accounting for energy requirements associated with takeoff, cruising to an incident location, and return travel.

5. The computer-implemented method of claim 1, wherein executing the drone deployment simulation engine includes:
computing a scheduling function, for each drone deployment configuration, by simulating drone assignment availability over time using launch and release events to determine the projected incident coverage level for a specified number of drones in a drone hive.

6. The computer-implemented method of claim 1, wherein executing the drone deployment simulation engine includes:
receiving design parameters including the specified target coverage level and a specified target on-station time, and
providing the performance metrics of the drone deployment configurations as input to the drone deployment optimization engine for selection of the drone deployment configuration with the performance metrics satisfying the design parameters.

7. The computer-implemented method of claim 1, wherein executing the drone deployment simulation engine includes:
generating the drone deployment configurations by varying a number of drone hives and the set of drone hive geolocations for each drone deployment configuration, and
executing a simulation for each drone deployment configuration.

8. The computer-implemented method of claim 7, wherein executing the drone deployment simulation engine further includes:
varying a number of drones assigned to each drone hive in the drone deployment configurations.

9. The computer-implemented method of claim 1, wherein executing the drone deployment simulation engine includes:
executing a data filtering module to filter the dataset of incident events based on user-defined geospatial parameters to generate a filtered dataset,
applying a clustering algorithm to the filtered dataset of incident events to determine the drone hive geolocations based on geographic incident density, and
executing the drone deployment simulation engine using the filtered dataset.

10. The computer-implemented method of claim 1, wherein determining the drone deployment configuration includes:
comparing drone response times against historical response times of ground-based units, and
selecting the drone deployment configuration based on a determination that the drone response times do not exceed the historical response times.

11. The computer-implemented method of claim 1, wherein receiving the operational constraint data includes:
rendering, via a second GUI, a map of a geographical area, and
receiving the geospatial constraint data based on user interaction with the map.

12. The computer-implemented method of claim 1 further comprising:
generating a graphical overlay of response zones for each drone hive, wherein each response zone is based on computed flight time and drone loiter capabilities.

13. The computer-implemented method of claim 1, wherein determining the drone deployment configuration includes:
ranking the drone deployment configurations based on a weighted performance score that includes response latency, drone utilization, and number of drone hives.

14. A system for configuring autonomous drone deployments for responding to incident events, comprising:
a processor and a memory storing instructions that, when executed, cause the processor to:
receive a dataset of incident events including timestamps and geospatial coordinates of the incident events;
receive design parameters including a specified target coverage level and a specified target on-station time;
for each of a plurality of drone deployment configurations:
execute a drone deployment simulation engine to compute, for each incident, performance metrics including a response time, an energy-constrained on-station duration, and total mission time based on drone specifications; and
execute a drone deployment optimization engine to:
evaluate the performance metrics for each drone deployment configuration to determine whether a drone deployment configuration satisfies the design parameters, and
output a selected drone deployment configuration including drone hive geolocations, number of drones per hive, and expected response performance metrics.

15. The system of claim 14, wherein the processor is configured to:
determine a first drone deployment configuration of the drone deployment configurations having the energy-constrained on-station duration satisfying the specified target on-station time and a projected incident coverage level satisfying the specified target coverage level, and
output the first drone deployment configuration as the selected drone deployment configuration.

16. The system of claim 15, wherein the processor is configured to:
compute a scheduling function, for the first drone deployment configuration, by simulating drone assignment availability over time using launch and release events to determine the projected incident coverage level.

17. The system of claim 14, wherein the expected response performance metrics includes a response time cumulative distribution function (CDF), and wherein the drone deployment optimization engine is configured to select the drone deployment configuration whose CDF satisfies a user-defined threshold.

18. The system of claim 14, wherein the processor is configured to:
receive geospatial constraint data including at least one of permitted drone operating zones and restricted airspace, and
execute a clustering algorithm based on geospatial constraints data, geographic incident density, and drone range limitations as input features to determine the drone hive geolocations for each drone deployment configuration.

19. A non-transitory computer-readable medium storing instructions that, when executed by one or more processors, cause a processing system to perform operations comprising:
obtaining incident event data including geospatial coordinates and timestamps;
obtaining geospatial constraint data specifying drone-restricted zones and candidate drone hive locations;
receiving design parameters including a specified target coverage level;
simulating autonomous drone operations over multiple drone deployment configurations to determine to compute performance metrics including projected incident coverage level based on the geospatial constraint data and the design parameters; and
selecting a drone deployment configuration including drone hive geolocations, drone count in each drone hive geolocation based on the projected incident coverage level satisfying the specified target coverage level.

20. The computer-readable medium of claim 19 further comprising instructions for:
executing a clustering algorithm based on geospatial constraint data, geographic incident density, and drone range limitations as input features to determine drone hive geolocations, and number of drones for each drone hive.
